(19) United States
(12) Patent Application Publication
(10) Pub. No.: US 2015/0222665 A1
(43) Pub. Date: Aug. 6, 2015

(54) RESTRICTING USER ACTIONS BASED ON DOCUMENT CLASSIFICATION

(71) Applicants: Peter Eberlein, Malsch (DE); Corneliu Mitu, Rauenberg (DE); Martin Kreyscher, Heidelberg (DE)

(72) Inventors: Peter Eberlein, Malsch (DE); Corneliu Mitu, Rauenberg (DE); Martin Kreyscher, Heidelberg (DE)

(21) Appl. No.: 14/170,021

(22) Filed: Jan. 31, 2014

(51) Int. Cl. H04L 29/06

(52) U.S. Cl. CPC H04L 63/20

(57) ABSTRACT

A system may include a request handler, a security policy checker, and a processor. The request handler may handle at least one requested action for a file on a mobile client device of a user side. The security policy checker may check the at least one requested action based upon a plurality of settings of the mobile client device. The processor may implement a permission in response to the at least one requested action. The security policy checker may generate the permission based upon the at least one requested action and the plurality of settings of the mobile client device, and the permission may comprise at least one of disabling the requested action, allowing the requested action, and modifying the requested action.

### RELATED APPLICATIONS

This application may be related to application number (attorney reference number 11884/532801) filed on Jan. 31, 2014, which may be incorporated herein by reference in its entirety.

### FIELD

The present invention relates generally to managing security of data files stored on centralized servers and accessed by mobile devices. More particularly, the present invention relates to systems and methods for maintaining security settings for different mobile device and OS platforms.

### BACKGROUND

As mobile electronic technology advances, user-side mobile devices may be increasing the demand for data more and more in the field. The mobile clients include, for example, desktop clients, web clients, iPhone/iPad clients and Android clients. The clients include applications configured to perform specific operations. The applications include receiving and sending data to a document management system which manages corporate data. The document management system provides a central interface for clients to share documents with a central database and other clients. These systems also provide for mechanisms to store documents and track changes being made to the documents.

As mobile client devices often leave the company premises and the web client might be accessed from outside the corporate network, business environments may need to handle different levels of security restrictions for different documents in different client devices and in different mobile application programs. The mobile client devices may need to be updated or reconfigured based on changes. For example, an application on the client may need to be upgraded in order for the client to be able to view a new file format used for the corporate documents. The application can be updated by an administrator manually updating the application on the client. The administrator may also send a notification to the client for the application to be updated by the user. However, with the large number of clients, different locations of mobile clients, and constant updates, it is difficult for all of the clients to be constantly kept up to date with the correct configurations.

Thus, there exists a need to restrict the possible actions that can be performed on corporate documents based on their document classification and device settings for flexible mobile access of documents, while maintaining maximum possible security.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an exemplary server system in a communication network according to an embodiment.

FIG. 2 illustrates an exemplary repository document classification setting user interface according to an embodiment.

FIG. 3 illustrates an exemplary Security Policies customization user interface s according to an embodiment.

FIG. 4 illustrates an exemplary sample documents directory user interface according to an embodiment.

FIG. 5 illustrates an exemplary method according to an embodiment.

FIG. 6 illustrates an example computer system according to an embodiment.

FIG. 7 illustrates a data management system according to an embodiment.

FIG. 8 illustrates a method for receiving configuration data for a client according to an embodiment.

FIG. 9 illustrates a method for providing configuration data on a data management system according to an embodiment.

### DETAILED DESCRIPTION

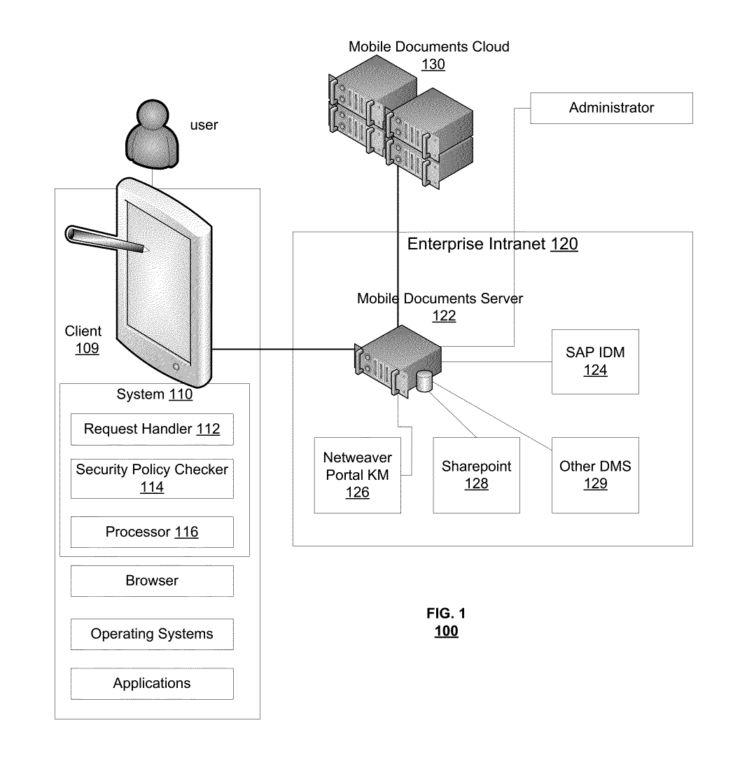

FIG. 1 illustrates an exemplary system 110 in a communication network 100 according to an embodiment.

According to an embodiment, a system 110 may include a request handler 112, a security policy checker 114, and a processor 116. The request handler 112 may handle at least one requested action for a file on a mobile client device 109 of a user side. The security policy checker 114 may check the at least one requested action based upon a plurality of settings of the mobile client device 109. The processor 116 may implement a permission in response to the at least one requested action. The security policy checker 114 may generate the permission based upon the at least one requested action and the plurality of settings of the mobile client device 109, and the permission may comprise at least one of disabling the requested action, allowing the requested action, and modifying the requested action.

The system 110 here may be included in the mobile client device 109 of a user side, or alternatively, part or all of system 110 may be implemented in a mobile documents server 122 or separately connected to the mobile document server 122. The mobile client device 109 and the system 110 may be connected, directly or indirectly to an enterprise intranet 120, which may be a secured computing network for a corporate or business entity or a group of users. The enterprise intranet 120 may include a mobile document server 122. The mobile document server 122 may be connected to a mobile documents cloud server 130, which may store document data in a cloud network. The mobile document server 122 may be connected to and administered by an administrator.

According to an embodiment, the security policy checker 114 may generate the permission by checking a plurality of security policies for entries matching the plurality of settings of the mobile client device 109.

According to an embodiment, the security policy checker 114 may generate the permission based upon a plurality of default security policies based upon the plurality of settings of the mobile client device 109 if the security policy checker 114 could not find entries matching the plurality of settings of the mobile client device 109.

According to an embodiment, for each document classification, a security policy may be defined.

According to an embodiment, the plurality of settings of the mobile client device 109 may include a plurality of user groups.

According to an embodiment, the plurality of settings of the mobile client device 109 may include a plurality of types of mobile client devices.

According to an embodiment, the plurality of settings of the mobile client device may include a plurality of types of operating systems.

Thus, the security policy checker 114 could find permissions for appropriate requested actions by looking for the entries matching the plurality of settings of the mobile client device 109, depending on what type of mobile client is used, what OS is being used, what programs are being executed/called, or what data environment (encrypted or not), etc.

The client 109 may also include browsers, operating systems, application programs stored on non-transitory storage mediums for execution.

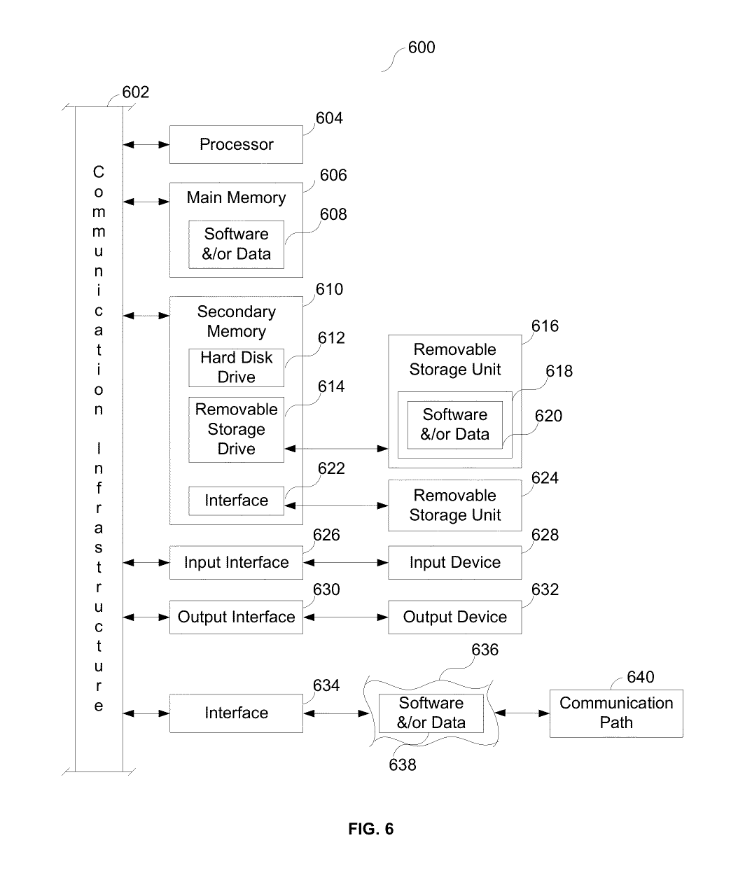

Aspects of the above may be implemented by software, firmware, hardware, or any combination thereof. FIG. 6 illustrates an example computer system 600 in which the above, or portions thereof, may be implemented as computer-readable code. Various embodiments of the above are described in terms of this example computer system 600.

Computer system 600 includes one or more processors, such as processor 604. Processor 604 can be a special purpose processor or a general purpose processor. Processor 604 is connected to a communication infrastructure 602 (for example, a bus or a network).

Computer system 600 also includes a main memory 606, preferably Random Access Memory (RAM), containing possibly inter alia computer software and/or data 608.

Computer system 600 may also include a secondary memory 610. Secondary memory 610 may include, for example, a hard disk drive 612, a removable storage drive 614, a memory stick, etc. A removable storage drive 614 may comprise a floppy disk drive, a magnetic tape drive, an optical disk drive, a flash memory, or the like. A removable storage drive 614 reads from and/or writes to a removable storage unit 616 in a well-known manner. A removable storage unit 616 may comprise a floppy disk, magnetic tape, optical disk, etc. which is read by and written to by removable storage drive 614. As will be appreciated by persons skilled in the relevant art(s) removable storage unit 616 includes a computer usable storage medium 618 having stored therein possibly inter alia computer software and/or data 620.

In alternative implementations, secondary memory 610 may include other similar means for allowing computer programs or other instructions to be loaded into computer system 600. Such means may include, for example, a removable storage unit 624 and an interface 622. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 624 and interfaces 622 which allow software and data to be transferred from the removable storage unit 624 to computer system 600.

Computer system 600 may also include an input interface 626 and a range of input devices 628 such as, possibly inter alia, a keyboard, a mouse, etc.

Computer system 600 may also include an output interface 630 and a range of output devices 632 such as, possibly inter alia, a display, one or more speakers, etc.

Computer system 600 may also include a communications interface 634. Communications interface 634 allows software and/or data 638 to be transferred between computer system 600 and external devices. Communications interface 634 may include a modem, a network interface (such as an Ethernet card), a communications port, a Personal Computer Memory Card International Association (PCMCIA) slot and card, or the like. Software and/or data 638 transferred via communications interface 634 are in the form of signals 636 which may be electronic, electromagnetic, optical, or other signals capable of being received by communications interface 634. These signals 636 are provided to communications interface 634 via a communications path 640. Communications path 640 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 616, removable storage unit 624, and a hard disk installed in hard disk drive 612. Signals carried over communications path 640 can also embody the logic described herein. Computer program medium and computer usable medium can also refer to memories, such as main memory 606 and secondary memory 610, which can be memory semiconductors (e.g. Dynamic Random Access Memory (DRAM) elements, etc.). These computer program products are means for providing software to computer system 600.

Computer programs (also called computer control logic) are stored in main memory 606 and/or secondary memory 610. Computer programs may also be received via communications interface 634. Such computer programs, when executed, enable computer system 600 to implement the present invention as discussed herein. In particular, the computer programs, when executed, enable processor 604 to implement the processes of aspects of the above. Accordingly, such computer programs represent controllers of the computer system 600. Where the invention is implemented using software, the software may be stored in a computer program product and loaded into computer system 600 using removable storage drive 614, interface 622, hard drive 612 or communications interface 634.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

It is important to note that the particulars of FIG. 6 (such as for example the specific components that are presented, the component arrangement that is depicted, etc.) are illustrative only and it will be readily apparent to one of ordinary skill in the relevant art that numerous alternatives (including inter alia other or different components, alternative arrangements, etc.) are easily possible.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

In an embodied example, companies might want to restrict requested actions, such as printing and email functions, for specific documents that may be classified as confidential to prevent data leakage to unauthorized individuals. Additionally, they might want to restrict the open-in action on mobile client devices that allows a document to leave the encrypted sandbox environment of the Mobile Documents applications and become opened in another, untrusted and/or unencrypted, mobile application that might store the document unencrypted, from which users without proper authorization may gain access.

The restricted actions may be determined from the document classification based upon the security policy settings related to the documents, the apps, and the mobile client devices:

For example, Document Classification Security Policy Restricted Action (permission).

A Document Classification may be set by a value like public or confidential and may be associated with a document (and not necessarily directly associated with a folder or a document container/collection). The Document Classification may be determined or set by the Mobile Documents server based on other properties associated with a document or defaulted by a configuration associated with a document repository.

A Security Policy may be a list of settings for actions or permissions that may be either allowed or restricted in a specific client. For example, for a specific mobile client device, requested actions such as printing may be allowed, but open-in action for an unsecured app may be restricted/disabled/modified. The Security Policy may be defined by the Mobile Documents administrator (or a data protection officer) via the Mobile Documents server and exposed to the Mobile Documents client devices as part of their client settings.

A Restricted Action may be a specific action like printing that may be restricted according to a security policy. The Restricted Actions may be disabled on the Mobile Documents client according to the Security Policy for the Document Classification of the respective documents. Additionally, an action may be disabled in some client configurations, however, if an alternative action that is similar to the disabled action is available and allowed in the security policy, the permission may be implemented to modify the disabled action to the alternative allowed action.

Document Classification

In FIG. 1, Document Management Systems (DMS) 124, 126, 128, and 129 in general may provide the capability to assign properties to documents. This may be often used by companies to store a classification value associated with each document. The Document Classification for each document may be assigned either manually or automatically. Automatic assignment may be performed by tools that scan the document content when the document is uploaded to the DMS to derive an appropriate classification value.

The Mobile Documents server 122 may act as a bridge to multiple DMS. When a DMS 124, 126, 128, and 129 is added as a repository to the Mobile Documents server 122, the property used for document classification and the value range for document classification may be configured in the repository configuration. As each DMS 124, 126, 128, and 129 might use different values, this configuration may be repository or DMS specific. The Mobile Documents server 122 may harmonize these different properties by for example, providing a standardized classification property to the clients with identifier mcm:classification with a secondary type mcm:classificationType. The values of this property may be mapped from the respective values of the classification property in the DMS 124, 126, 128, and 129 according to a mapping that may be configured together with the classification property itself in the repository configuration. As a result of this mapping, the mcm:classification property for a DMS 124, 126, 128, and 129 may have one of the following exemplary defined values: public, customer, internal, confidential, strictly_confidential. These values may be customizable with additional values as needed for different purposes.

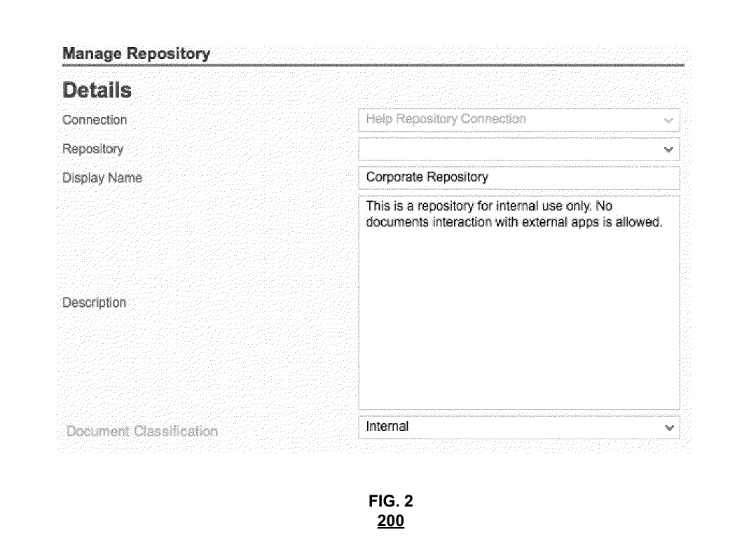

For DMS 124, 126, 128, and 129 where no such classification property may be defined (and for the initial implementation of the Document Classification concept in Mobile Documents), the classification may be determined by a default value configured for the repository (see FIG. 2). Otherwise this default may be only used if the DMS specific classification property not set on a specific document.

FIG. 2 illustrates an exemplary repository document classification setting user interface 200.

Here, a specific repository is set to have default value of “internal” for all document classification. This default value may be used for all documents in the repository, unless a different value (for a different policy) is specifically set for a specific document in this repository.

Security Policies to Determine Permissions

For each Document Classification, the Mobile Documents administrator (data protection officer) may define a security policy that determines which of the following actions may be restricted and have to be disabled to implement permissions for specific documents. Table 1 below illustrates an example set of security policy with various example actions with descriptions (other actions may be implemented as needed based upon specific application requirements or features):

TABLE 1

| Action | Description | Checked on | Applies to |
|---|---|---|---|
| list* | Documents and folders for which listing is | Client/Server | Mobile, Web |
| | disabled may be not listed when browsing. This | | App, Desktop |
| | effectively disables all following options. | | |
| open | Documents for which the open action may be | Client/Server | Mobile, Web |
| | disabled may be not downloaded to the device. | | App, Desktop |
| | This effectively disables all following options | | |
| sync | Documents may be still cached for offline use | Client | Mobile |
| | unless the maximum cache size is set to 0. | | |
| print | Disables AirPrint (mobile print) | Client | Mobile |
| copy | Disables copying (or moving) the document to | Client/Server | Mobile, Web |
| | another location within the same repository or | | App, Desktop |
| | across repositories. Renaming a document may | | |
| | be still possible. | | |
| clipboard | Disables the clipboard for copy & paste of | Client | Mobile |
| | selected document content | | |
| send | Disables in-app sending (email, airdrop, . . . ) | Client | Mobile |
| publish | Disable publishing | Client/Server | Mobile, Web |
| | | | App, Desktop |
| open_in | Prevents documents from leaving the app | Client | Mobile |
| | sandbox (encrypted) to be opened in other | | |
| | apps (unencrypted). | | |

Some of the actions may only be checked on the client while there may be others that could be checked on the server as well (see the “Checked on” column in Table 1 above). In case of the list action this could also improve performance if checked on server side, as metadata for documents not to be listed would not need to be transferred to the client, and the filtering of the listing may be done on the server beforehand to generate the filtered listing to be sent to the client side. For this, the server may need to know which type of client the metadata was requested from, which could be based on information in the user-agent header. This header may be easily forged; thus, performing checks on the server might not increase security but may be only achieve some overall system performance improvements.

Security Policies may be stored and/or changed in the client settings for each client type according to exemplary embodiments as follows.

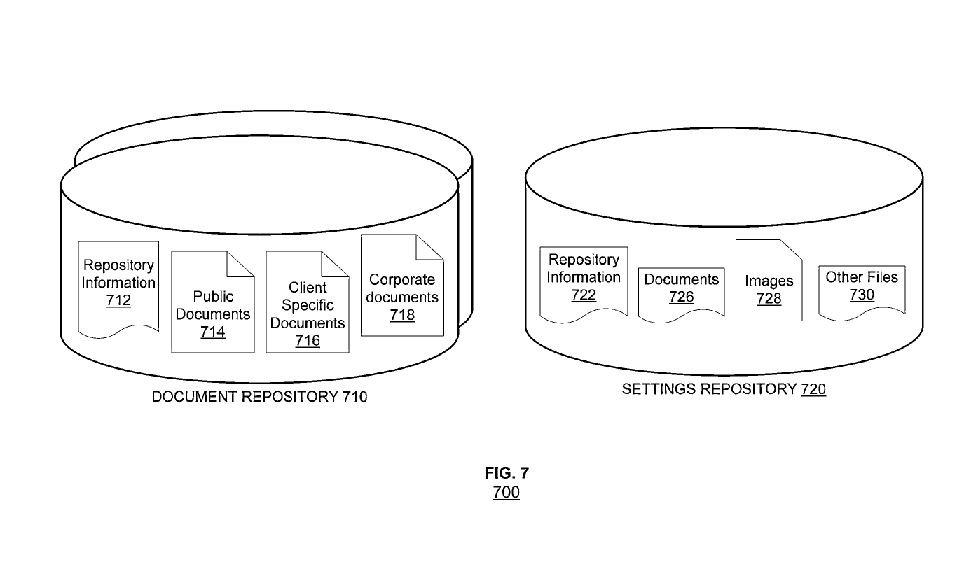

FIG. 7 illustrates a data management system 700 according to an embodiment of the present disclosure. The data management system may correspond to or may be implemented in one or more of the data management systems DMS 124, 126, 128, and/or 129 shown in FIG. 1. The data management system 700 may include a plurality of repositories 710, 720. The repositories 710, 720 may be root entities under which documents are organized in folder structures.

Each repository 710, 720 may be dedicated for a particular data type, application and/or group of users or devices. Each repository 710, 720 may be a different storage device managed by the data management system. In another embodiment, a plurality of repositories 710, 720 may all be parts of a single storage device. The repositories 710, 720 may merge data from different sources (e.g., client devices 109) without data replication.

Each repository 710, 720 may include repository information 712, 722, respectively. The repository information 712, 722 may include details about the repository. The repository information 712, 722 may include, for example, the repository identification, repository location (e.g., on the network or the World Wide Web), types of files stored, and information on the files stored in the repository. The information on the files stored in the repository may include list of the files, their locations, request history, and history of changes.

As shown in FIG. 7, the document repository 710 may include public documents 714, client specific documents 716 and corporate documents 718. The public documents 714 may include documents that can be accessed by anyone having access to the document repository. The public documents 714 may include documents that can be downloaded by a user via a public webpage. The client specific documents 716 may include documents that belong to or were generated by a specific user and/or a specific client device. The corporate documents 718 may include documents that can be accessed and manipulated by users and/or client devices that are part of the company.

As shown in FIG. 7, one of the managed repositories may include a settings repository 720. The settings repository 720 may provide data to configure applications and/or client devices accessing data in the data management system 700. The files in the settings repository 720 may allow for the applications and the devices to automatically be configured using the data in the settings repository 720. The configuration data may include data that is specific for the client device, an application, version of the application, and/or a user associated with the application or client device. The configuration data may be provided as one or more text documents that can be viewed and/or edited with any number of text viewers or editors.

The settings repository 720 may include documents 726, images 728 and other files 730. These files may provide the configuration data to apply administrative settings, user settings, security relevant settings, and theming content (e.g., corporate logos, template or configurations). In one embodiment, a single settings document 726 may provide the configuration settings for various applications or the devices. The settings document 726 may provide details for other files to be used in the configuration of the application or the device. For example, the settings document may provide the name and location of files for corporate logos or templates.

In one embodiment, a different settings document 726 may be provided for each different type of device or application accessing the settings repository 720. For example, a first settings document may provide the settings for mobile operating systems, a second settings document may provide the settings for desktop client settings, and a third settings document may provide the settings for web clients. Each client may request a document with the settings corresponding to the type of device requesting the settings document. Each of the settings documents may include general settings, security settings, security policies, and theme settings.

The general setting may provide application or device requirements and basic settings for these devices. For example, the general settings may include the minimum version (e.g., client version, application version or operating system version), recommended version, cache size, support log setting, support E-mail settings, synchronization interval, and bandwidth settings.

The minimum version may be provided as a text filed with the version string. A client with a lower version than the minimum version may require for the user to upgrade to at least the minimum version in order to run the application or access the data on the data management system 700. The recommended version may include a text filed with the version string. A client with a lower version than the recommended version may be notified with a recommendation to upgrade the client version to the recommended version.

The cache size may include a minimum and/or a maximum cache size to be implemented on the client. The administrator may set these settings based on the requirements of the data management system 700, the client device, the application, or files that are to be viewed or executed at the client device. The maximum cache size may provide the maximum size that the user may set on the client device. For example, the maximum cash may be set to 50 MB, 100 MB, 1000 MB, or 5000 MB. In one embodiment, the maximum cache size may not be set to provide no limit. To disable cashing, the maximum cache size may be set to zero. The minimum cache size may provide a minimum cache size that is needed on the client device. The user may set the cache size to a higher value but may need to provide at least the minimum cache size.

The support log settings may include whether the support log is disabled or not. If the support log is disabled the user may not activate the support log on the client device. The defaults setting for the support log settings may be set to being enabled.

The support e-mail settings may include an e-mail address to which to send support requests. The support e-mail settings may be used by an application to provide an option to send a support request to the data management system 700 or an administrator. When the support log setting is enabled to provide a support log, the support log may be included with the support request.

The synchronization interval may provide a minimum time interval that should be used between synchronization of the documents in the data management system 700 and the client device (e.g., in the memory or cache of the client device). An option may be provided for the user to set the time interval to a larger, but not smaller, synchronization interval. This setting may be applied to, for example, desktop client settings which may be continuously connected to the data management system 700.

The bandwidth settings may include a maximum and/or a minimum bandwidth setting between the client device and the data management system 700. For example, the maximum bandwidth may be set based on the available bandwidth and the number of clients that are expected to connect to the data management system 700. The user may be provided with an option to set a bandwidth that is lower but not higher than the maximum bandwidth. Like other settings, the bandwidth settings may be set based on the type of device (e.g., mobile device, desktop client or web client) and/or the type of application that is accessing the data management system 700.

The security settings may include settings for the password of the client device and/or application. The security settings may include whether an application password is required. If the password is not required the user may still set an application password but it will not be required. The security settings may include a lock timeout setting set to a predetermined time period (e.g., 0, 60, 300 or 600 seconds). The lock timeout setting may provide for how long the password does not have to be re-entered if the application is in the background for the predetermined time period. The user of the client device may set the value to a smaller value but not to a longer period. The security settings may also include a maximum number of failed password attempts, minimum password length, requirement for password to include a lowercase character, requirement for the password to include an uppercase character, requirement for the password to include a digit, and the password to include a special character.

The security policy settings may include a security policy for documents or folders based on the document or folder classification. The classifications may include strictly confidential, confidential, internal, customer, and public. The security policy may allow or restrict specific actions within the application on the documents or folders based on the classifications. The security policy may include whether the document classification visible to the user, whether document can be opened (e.g., downloaded and displayed) on the client device, whether the document can be cached for offline use, whether the document can be printed, whether the document or a portion of the document can be copied, whether the document can be sent in an e-mail, whether the document can be externally shared, and whether the document can be opened in other applications on the client device.

The theme settings may include themes or templates of the company that can be applied to the client device. The theme settings may include links to data on the data management system 700. For example, the theme setting may include a link to an image that should be used as the company logo in the application. Other examples of the theme setting may include colors, fonts and background images to be used in the applications and/or the client device.

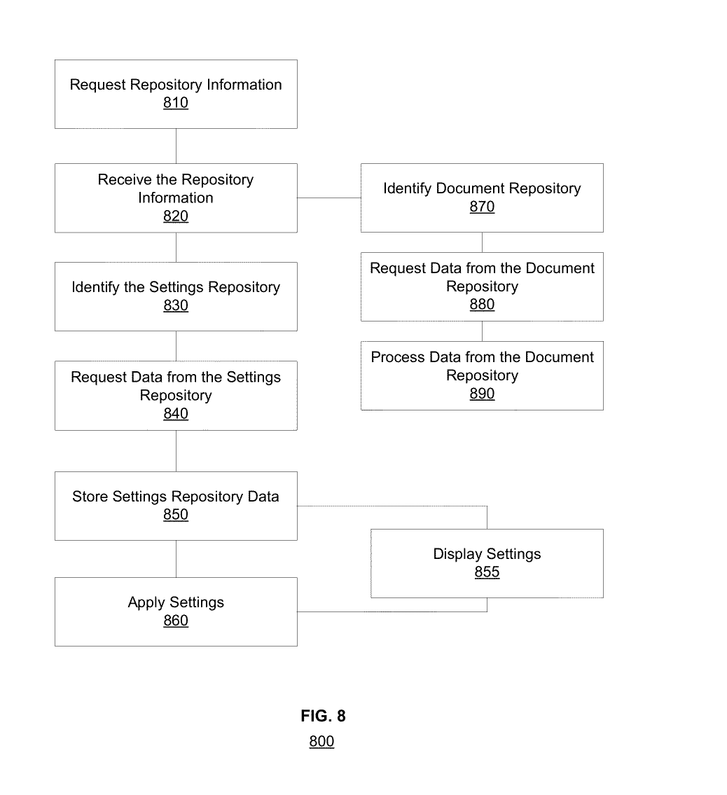

FIG. 8 illustrates a method 800 for receiving configuration data for a client according to an embodiment of the present disclosure. The method may be performed by or in one or more of the data management systems DMS 124, 126, 128, and/or 129 shown in FIG. 1. The method 800 may include requesting repository information (block 810), receiving repository information (block 820), identifying the settings repository (block 830), requesting data from the settings repository (block 840), storing settings repository data (block 850), and applying the settings (block 860).

Requesting repository information (block 810) may include sending a request by the client to a data storage device. The request may be sent in response to a user request or in response to an operation performed on the client device. For example, the request may be sent automatically when a user logs into the client device or application, when an application is started, or when a request for data is sent to the storage device. In one embodiment, the request may be sent periodically (e.g., once a day) to the data storage device. The request may include information on the client device, application, and/or the user making the request. In one embodiment, the request may include a user ID and password. The request may also include client security policy identifying the level of access the user may have to the data in the data storage device.

In response to the request, the client may receive the repository information (block 820). The repository information may be sent by the data storage device and may include details on the data that is stored in the data storage device. This data may include a listing of the repositories and the data that is stored in each repository. In one embodiment, the data may include a file directly of the data storage device. The repository information received from the data storage device may include only information for repositories to which the client has authorization to access.

In one embodiment, the repository information may be automatically received from the data storage device without needing a request. In this embodiment, the repository information may be sent periodically to the client devices which have been confirmed to have authorization to receive the repository information.

Identifying the settings repository (block 830) may include analyzing the received repository information to determine if the data storage device includes a setting repository. If a settings repository is included in the received repository information, a request may be sent for data from the settings repository (block 840). The setting repository information may be identified by searching for the settings extension in the extension elements of the repository information. The repository information may provide the settings folder ID which may server as the anchor point into the settings folder structure in the settings repository. In one embodiment, the client may identify the settings repository and a settings document or folder that is specific to the type of client requesting the settings data.

Requesting data from the settings repository (block 840), may include requesting a settings document (e.g., settings document 726 discussed shown in FIG. 7). The request may include requesting data (e.g., a settings document) that is specific to the client and/or applications on the client. The settings document may provide configuration settings for the client and/or the applications on the client.

Based on the data in the settings document, additional data (e.g., images and other files) may be requested from the settings repository and/or the document repository. For example, based on the information in the settings document the client may determine which image the client needs to download from the settings repository and use as the logo in an application. The client applications may use regular data management service to navigate and retrieve data the folder structure of the settings repository.

The received settings repository data may be stored (block 850) on the client. In one embodiment, the settings repository data may be stored in memory on the client to keep a synced copy of the settings repository data. In another embodiment, the settings repository data may be stored in cache of the client to determine and apply the configurations provided in the settings repository data.

In one embodiment, requesting data from the settings repository (block 840) may include requesting all of the content in the settings repository. The settings repository content may be stored (block 850) in memory of the client. This embodiment may be applicable to clients (e.g., desktop application or mobile application) which keep the data repository content in sync with the data storage device. The client may use the settings data stored on the client even when the client device cannot connect to the data storage device (e.g., when client is offline).

In one embodiment, the client may request (block 840) data from the settings repository on demand (e.g., web applications). The client may access the configuration data by name using regular data management system service. The document names relevant for the individual client may be included in the respective client application or referenced by other settings documents. The data requested on demand may be stored (block 850) temporarily in the client cache.

The settings repository data may be displayed to the client (block 855). For example, when the settings repository data is received, the client may be notified of settings that do not conform to the current settings and provide recommended and/or required actions. The client may also view the settings document using a text viewing or editing application.

The method 800 may include applying the settings (block 860) based on configuration data in the settings repository. The settings may be applied to the client as soon as the document with the settings is synced to the client. For example, an application on the client may be upgraded to the recommended application version when a document is received identifying the recommended application version. In one embodiment, the client may download and apply a background image on the client an image which is identified in the settings document.

As shown in FIG. 8, the method 800 may also include identifying a document repository (block 870), requesting data from the document repository (block 880), and processing data from the document repository (block 890). Identifying the document repository (block 870) may include identifying data repositories in the data storage device which can be accessed by the client. The document repository may include data that is synched with the data on the client. Data from the document repository may be requested (block 880) and synched (block 890) with the data on the client. The data from the document repository may be processed (e.g., modified analyzed) by applications on the client.

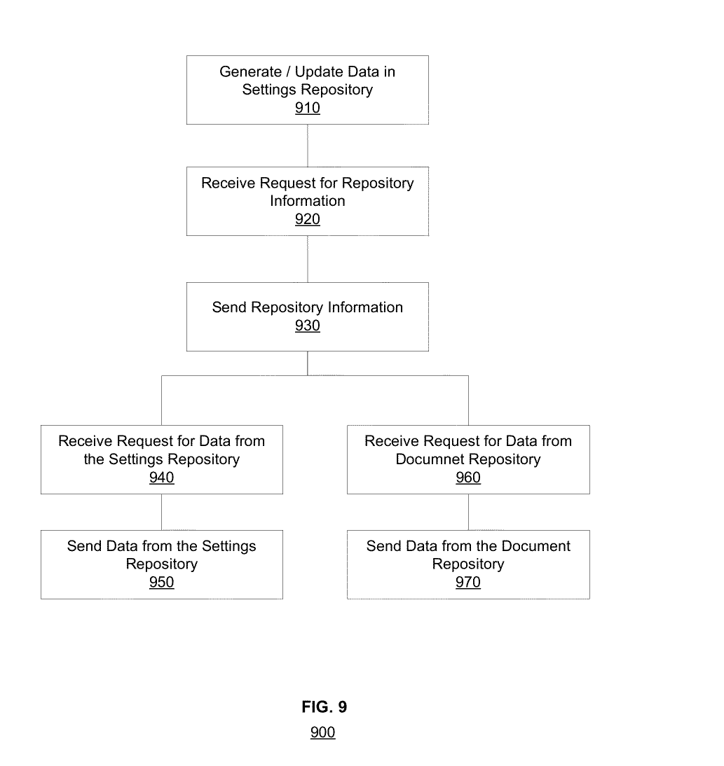

FIG. 9 illustrates a method 900 for providing configuration data on a data management system according to an embodiment of the present disclosure. The method may be performed by the data storage device 120, shown in FIG. 1. The method 900 may include generating or updating data in the settings repository (block 910), receiving request for repository information (block 920), sending repository information (block 930), receiving request for data from the settings repository (block 940), and sending data from the settings repository (block 950). The method 900 may also include receiving request for data from a document repository (block 960) and sending data from the document repository (block 970).

Generating and/or updating data in the settings repository (block 910) may include a user providing configuration data for a client in a settings document. In one embodiment, a separate settings document may be provided for each type of client or application. In another embodiment, a single settings document may be provided for different client or applications. The settings document(s) may be stored in a data storage device. The data storage device may include a plurality of repositories including document repositories and a settings repository. The settings document(s) may be stored in the settings repository of the data storage device.

The settings document may be created or edited using regular document operations provided by the data storage device storing the settings document. In one example, an administrator may open the settings document in a text editor and add settings items in the document. The settings may be provided as name-value pairs. The name-value pairs may provide for settings to be defined without breaking existing settings. It also may not be required to provide a dedicated user interface on the server side to maintain the settings document.

In other embodiments, the data in the settings repository may be configured via a user interface. The user interface may allow for the user to be presented with settings options and to receive settings from the user. In one embodiment, a hybrid administration strategy may be provided in which an administrator user interface is provided to edit currently defined setting and the additional settings may be included with a text editor. In this embodiment, the text editor may be used to edit the settings for values that the user interface has not been configured to handle (e.g., due to an outdated version of the user interface). Once the user interface is update, there may be no need to use the text editor to set the settings in the settings document.

In addition to the settings document, other files (e.g., images, documents and videos) that are associated with the configuration of the clients may be stored in the settings repository (e.g., in a folder containing the settings document).

Receiving a request for repository information (block 920) may include receiving a request from one or more clients. The request may include information on the client device, application, and/or the user making the request. In one embodiment, the request may include a user ID and password. The request may also include client security policy identifying the level of access the user may have to the data in the data storage device.

In response to the request (block 920), the method 900 may include sending the repository information (block 930). The repository information may include details on the data that is stored in the data storage device. This data may include a listing of the repositories (e.g., document repositories and settings repository) and the data that is stored in each repository. In one embodiment, the repository information received from the data storage device may include only information for repositories to which the client has authorization to access.

Receiving request for data from the settings repository (block 940) may include receiving a request from the client for a setting document stored in the settings repository. In one embodiment, the request may include receiving all of the data stored in the settings repository or all of the data in the settings repository to which the client has access.

In response to the request (block 940), the method 900 may include sending data from the settings repository (block 950). Depending on the request, the sent data may include a single file or a predetermined content of the settings repository. The predetermined content of the settings repository may include a specific folder in the settings repository or content to which the client has authority to access.

In one embodiment, the data from the settings repository may be sent periodically to the client to keep an updated copy of the settings with the client. In another embodiment, the data from the repository may be sent to the client every time changes are made to the data in the settings repository. The data that is sent to the client may include only the changes (e.g., deltas) in the settings data. In this embodiment, the data sent to the client may include the settings document and files which have been modified or changed.

Receiving request for data from the document repository (block 960) may include receiving a request from the client for data stored in document repository of the data storage device. The request may be received periodically or when the user of the client makes the request.

In response to the request (block 960), the method may send the requested data from the document repository (block 970) to the client. The data from the document repository may be sent periodically to the client to keep an updated copy of the data at the client. In another embodiment, the data from the repository may be sent to the client every time changes are made to the data in the document repository (e.g., changes made by other clients).

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

Different client settings can be assigned to different user groups, so that security policies may be user dependent. Additionally, client types could be further qualified or defined to match appropriate security policies to determine permissions for requested actions, for example mobile devices may be differentiated by operating system types (iOS, Android, Windows), by hardware types, and by ownership types, i.e. company owned or bring your own device (BYOD).

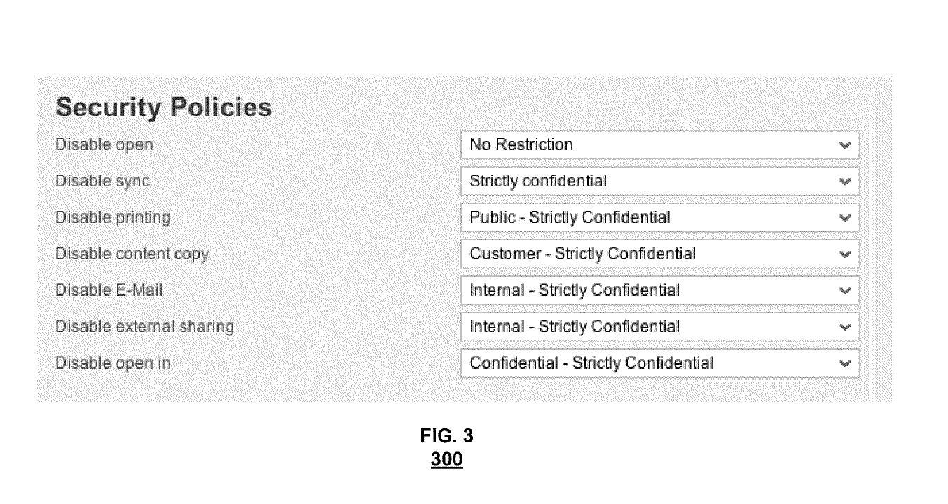

FIG. 3 illustrates an exemplary Security Policies customization user interface 300. While for each classification a separate Security Policy may be created, from an administrator's perspective the configuration of a full set of Security Policies per client may be combined into one user interface 300 to be displayed and/or modified on a screen.

The administrator configures the range of classifications for which a specific action may be restricted by only selecting the minimum classification level. The appropriate minimum restriction then may be implemented for all classifications equal or greater than the selected level. For example, in user interface 300, disable E-mail is selected for “Internal—Strictly Confidential” classification level. Thus, all documents with “Internal—Strictly Confidential” classification level or higher (higher level classified documents) will have their E-mail action disabled, to prevent the documents from being allowed to be emailed.

Nevertheless separate Security Policies may be generated for each classification so that clients can directly retrieve the respective policy based on the concrete classification of the document under observation but the administrator only needs to make one selection instead of five.

Alternatively, advanced configuration options may be allowed that may be not based on classification levels that would provide even more flexibility not limited by ranges in classification levels, for example, based upon specific combinations of client devices.

Classifications may be ordered by classification levels, for example, according to Table 2 below.

TABLE 2

| Classification Level | Classification | Name |
|---|---|---|
| 0 | public | Public |
| 1 | customer | Customer |
| 2 | internal | Internal |
| 3 | confidential | Confidential |
| 4 | strictly_confidential | Strictly Confidential |

Restricted Actions and Permissions

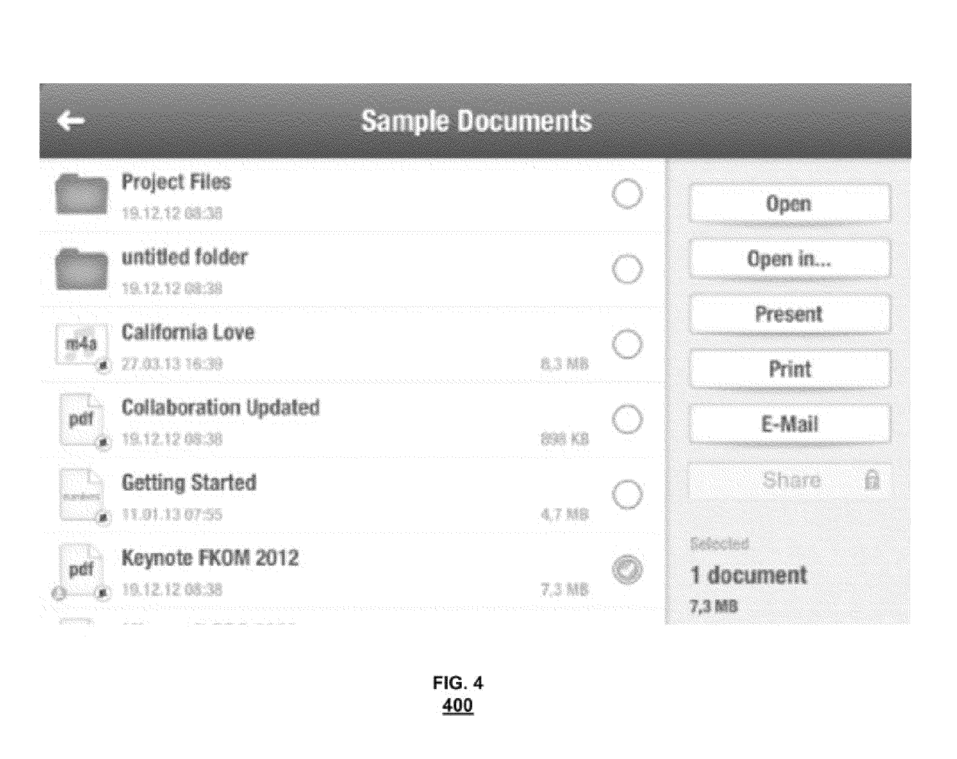

FIG. 4 illustrates an exemplary sample documents directory user interface 400. The Security Policy for a client determined by the Document Classification may determine the permissions appropriate for each action if it may be allowed or restricted or modified. Restricted Actions may be disabled in the user interface on that client so the user cannot execute these actions.

As illustrated in FIG. 4, a document “Keynote FROM 2012” is selected. On the right side of the user interface 400, actions “open”, “open in”, “present”, “print”, and “e-mail” remain allowed and thus may be clicked by the user to execute those actions. However, “share” action is shown with a locked symbol on the right. Thus, “share” action may not be executed for this document.

If the user selects multiple documents at the same time, the set of Restricted Actions may be merged from all determined Security Policies. If an individual action may be restricted for one of these policies, the action may be disabled for all documents. For example, if the user selects one document classified as public and another one classified as confidential and sharing may be allowed for public documents but restricted for confidential documents, then these two documents cannot be shared together. When user deselects the confidential document and only the public document remains selected, sharing may be enabled again.

Alternative, merging Security Policies may allow to restrict actions individually for each Security Policy or different documents, not limited to ranges in classification levels. For example, multiple documents with different security policies may merge to present a “share” action that is partially allowed, by highlight “share” allowed document if user move cursor over “share” action, and/or executing “share” action only for the documents that allow “share” action.

Benefits

This solution allows administrators of Mobile Documents to restrict the actions that their users can execute on documents based on their document classification and individual per client application. This enables companies to prevent data leakage of confidential documents while at the same time offering gradually more flexibility for less sensitive information.

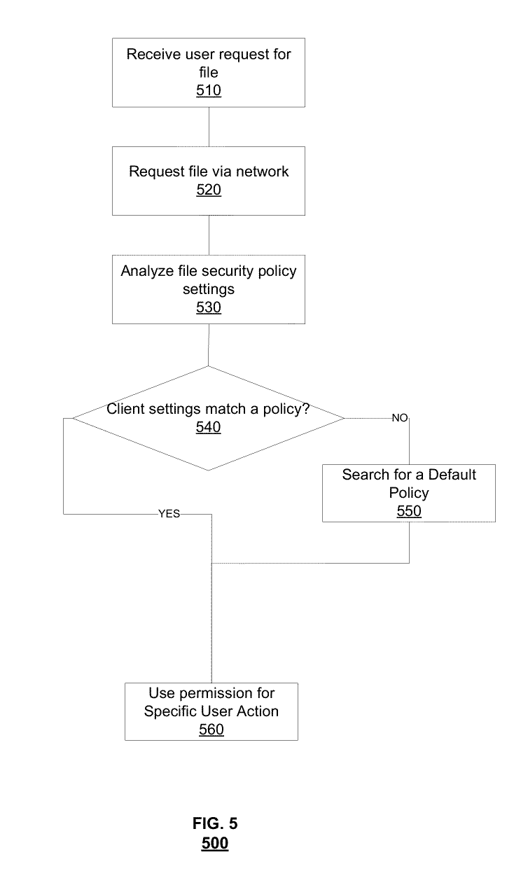

FIG. 5 illustrates an exemplary method 500.

At block 510, the system may receive user request for actions relating to files.

At block 520, the system may request the files for action via network.

At block 530, the system may analyze security policies for requested actions based upon client settings.

At block 540, the system determines whether there is a security policy matching the client settings for the requested actions.

If there is no matching policy, at block 550, the system may search for a default policy based upon the client settings, or based upon the repository settings, for the requested actions.

At block 560, once a matching security policy or a default security policy is determined, the appropriate permissions of the determined security policy may be implemented for requested actions.

It may be appreciated that the disclosure may be not limited to the described embodiments, and that any number of scenarios and embodiments in which conflicting appointments exist may be resolved.

Although the disclosure has been described with reference to several exemplary embodiments, it may be understood that the words that have been used may be words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure may be not intended to be limited to the particulars disclosed; rather the disclosure extends to all functionally equivalent structures, methods, and uses such as may be within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as code segments in computer-readable media, it may be to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present specification describes components and functions that may be implemented in particular embodiments with reference to particular standards and protocols, the disclosure may be not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein may be intended to provide a general understanding of the various embodiments. The illustrations may be not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations may be merely representational and may not be drawn to scale. Certain proportions within the illustrations may be exaggerated, while other proportions may be minimized. Accordingly, the disclosure and the figures may be to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure may be intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than may be expressly recited in each claim. Rather, as the following claims reflect, inventive subject matter may be directed to less than all of the features of any of the disclosed embodiments. Thus, the following claims may be incorporated into the Detailed Description, with each claim standing on its own as defining separately claimed subject matter.

The above disclosed subject matter may be to be considered illustrative, and not restrictive, and the appended claims may be intended to cover all such modifications, enhancements, and other embodiments which fall within the true spirit and scope of the present disclosure. Thus, to the maximum extent allowed by law, the scope of the present disclosure may be to be determined by the broadest permissible interpretation of the following claims and their equivalents, and shall not be restricted or limited by the foregoing detailed description.

We claim:

1. A system, comprising:
a request handler handling at least one requested action for a file on a mobile client device of a user side;
a security policy checker checking the at least one requested action based upon a plurality of settings of the mobile client device; and
a processor implementing a permission in response to the at least one requested action,
wherein the security policy checker generates the permission based upon the at least one requested action and the plurality of settings of the mobile client device, and the permission comprises at least one of disabling the requested action, allowing the requested action, and modifying the requested action.

2. The system of claim 1, wherein the security policy checker generates the permission by checking a plurality of security policies for entries matching the plurality of settings of the mobile client device.

3. The system of claim 2, wherein the security policy checker generates the permission based upon a plurality of default security policies based upon the plurality of settings of the mobile client device if the security policy checker could not find entries matching the plurality of settings of the mobile client device.

4. The system of claim 2, wherein a document classification corresponds to a respective one of the plurality of security policies defined.

5. The system of claim 1, wherein the plurality of settings of the mobile client device comprises a plurality of user groups.

6. The system of claim 1, wherein the plurality of settings of the mobile client device comprises a plurality of types of mobile client devices.

7. The system of claim 1, wherein the plurality of settings of the mobile client device comprises a plurality of types of operating systems.

8. A method of a system, comprising:
handling, by a request handler, at least one requested action for a file on a mobile client device of a user side;
checking, by a security policy checker, the at least one requested action based upon a plurality of settings of the mobile client device; and
implementing, by a processor, a permission in response to the at least one requested action,
wherein the security policy checker generates the permission based upon the at least one requested action and the plurality of settings of the mobile client device, and the permission comprises at least one of disabling the requested action, allowing the requested action, and modifying the requested action.

9. The method of claim 8, wherein the security policy checker generates the permission by checking a plurality of security policies for entries matching the plurality of settings of the mobile client device.

10. The method of claim 9, wherein the security policy checker generates the permission based upon a plurality of default security policies based upon the plurality of settings of the mobile client device if the security policy checker could not find entries matching the plurality of settings of the mobile client device.

11. The method of claim 9, wherein a document classification corresponds to a respective one of the plurality of security policies defined.

12. The method of claim 8, wherein the plurality of settings of the mobile client device comprises a plurality of user groups.

13. The method of claim 8, wherein the plurality of settings of the mobile client device comprises a plurality of types of mobile client devices.

14. The method of claim 8, wherein the plurality of settings of the mobile client device comprises a plurality of types of operating systems.

15. A non-transitory computer readable medium storing program codes executable by a processor of a server system, to perform:
handling, by a request handler, at least one requested action for a file on a mobile client device of a user side;
checking, by a security policy checker, the at least one requested action based upon a plurality of settings of the mobile client device; and
implementing, by a processor, a permission in response to the at least one requested action,
wherein the security policy checker generates the permission based upon the at least one requested action and the plurality of settings of the mobile client device, and the permission comprises at least one of disabling the requested action, allowing the requested action, and modifying the requested action.

16. The non-transitory computer readable medium of claim 15, wherein the security policy checker generates the permission by checking a plurality of security policies for entries matching the plurality of settings of the mobile client device.

17. The non-transitory computer readable medium of claim 16, wherein the security policy checker generates the permission based upon a plurality of default security policies based upon the plurality of settings of the mobile client device if the security policy checker could not find entries matching the plurality of settings of the mobile client device.

18. The non-transitory computer readable medium of claim 16, wherein a document classification corresponds to a respective one of the plurality of security policies defined.

19. The non-transitory computer readable medium of claim 15, wherein the plurality of settings of the mobile client device comprises a plurality of user groups.

20. The non-transitory computer readable medium of claim 15, wherein the plurality of settings of the mobile client device comprises a plurality of types of mobile client devices or a plurality of types of operating systems.
